(19) United States
(12) Patent Application Publication
(10) Pub. No.: US 2010/0300725 A1
(43) Pub. Date: Dec. 2, 2010

(54) ELECTRIC-WIRE CABLE EQUIPPED WITH FOAMED INSULATOR

(76) Inventors: Akinari NAKAYAMA, Hitachinaka (JP); Hideyuki Suzuki, Hitachi (JP); Yuji Endo, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/788,430

(22) Filed: May 27, 2010

(30) Foreign Application Priority Data
May 28, 2009 (JP) 2009-128919

(51) Int. Cl. H01B 3/30

(52) U.S. Cl. 174/110 SR

(57) ABSTRACT

There is provided an electric-wire cable equipped with a foamed insulator, the foamed insulator molded on an outer periphery of a metal conductor by a physical foaming method, in which: the foamed insulator is made of a blend of crystalline polymer A with polymer B; and the crystal melting point or glass transition temperature of the polymer B is between the crystal melting point of the crystalline polymer A and a temperature 50° C. lower than the crystal melting point of the crystalline polymer A.

### CLAIM OF PRIORITY

The present application claims priority from Japanese patent application serial no. 2009-128919 filed on May 28, 2009, the content of which is hereby incorporated by reference into this application.

### BACKGROUND OF THE INVENTION

1. Field of the Invention

The present invention relates to an electric-wire cable having a foamed insulator.

2. Description of Related Art

With the recent progress of information and communication networks, data transmission cables used between apparatuses must cope with high speed and large capacity, and excellent transmission characteristics at high frequency are required. Specifically, in recent years, an increasing number of apparatuses adopt a method called “differential transmission” in which plus and minus voltages are applied to a two-core cable. This differential transmission method achieves high resistance against an extrinsic noise, while the method has restriction of strictly controlling a signal transmission time difference (delay time difference: skew) between the two cores of the cable. This is to prevent communication errors that may occur in the receiving-side apparatus as the result of the occurrence of time difference between signals transmitted from a plurality of core wires.

Skew is a delay time difference between individual electric wires and significantly relates to a dielectric constant of the insulator of the electric wire. And a high-speed transmission cable requires an insulator having a low dielectric constant and thereby a high foaming degree. Therefore, the foaming degree of the insulator is the most important factor. To suppress fluctuation of the foaming degree, making bubbles fine is effective. In addition, to conduct differential transmission, the degree of foaming must be uniform. See, e.g., JP-A 2008-303247, JP-A 2008-255243, JP-A 2006-233085, and JP-A Hei 6(1994)-049261.

Generally, there are two foaming methods: One is a method that uses a chemical foaming agent (chemical foaming); and the other is a method in which gas is infused into molten resin in an extruder and foaming is executed due to a pressure difference between an inside and outside of a die of the extruder (physical foaming). The chemical foaming method is advantageous since it is easy to obtain an insulator having a foaming degree that does not fluctuate much. However, there are problems in that it is difficult to achieve a high foaming degree and the dielectric constant of the insulator becomes large in relation to the degree of foaming because the dielectric constant of foaming agent residue is prone to become large. For this reason, foamed insulators manufactured by the physical foaming method are mostly used for the cables used for high-speed differential transmission.

On the other hand, an insulator having a high foaming degree generally has a small amount of resin, causing problems in which mechanical strength is insufficient and deformation and buckling easily occur. In order to prevent these problems, there is a method to reinforce the foamed insulators by means of a cable jacket and the like, though, the optimal method to maintain stable performance of the foamed insulators is to make bubbles fine, thereby dispersing load and stress. That is, an ideal cable is a cable which has a large number of fine and uniform bubbles and has no (least) fluctuation of the foaming degree throughout the entire length.

In order to maintain a certain degree of foaming while making the bubbles fine, a large number of bubbles need to be generated, and it is important to select a foam nucleating agent. Generally-used foam nucleating agents are inorganic particles, such as clay, silica and the like, high-melting point polymers, such as PTFE (polytetrafluoroethylene) powder and the like, and organic chemical foaming agents (azodicarbonamide (ADCA), 4,4′-oxybis(benzensulfonylhydrazide) (OBSH), and the like). Although optimal composition and shape of the foam nucleating agent differ according to the base resin and processing conditions, basically, it is well-known that the number of generated bubbles increases with becoming small the particles since the number of added particles significantly increases even though the amount of addition is the same.

However, a nucleating agent of fine particles easily agglomerates and it is very difficult to uniformly disperse the agent in the resin. That is, when fine particles are simply added to resin, agglomeration of the fine particles occurs, resulting in fluctuation of the foaming properties and, in the worst case, causing an adverse effect on the properties of the resin composition.

In order to overcome the flocculation problem, master batch (MB) of the nucleating agent is usually formed. In this method, MB is prepared by mixing a highly-concentrated nucleating agent with resin using a special kneading machine, and the MB is diluted in an electric-wire extruder (foam extruding machine), thereby preventing extremely defective dispersion. Although this method improves the dispersion condition to some extent, multi-stage processing of material is required, which is prone to arise other problems in that material (processing) costs increase and properties of material change due to processing history. Consequently, because of the flocculation problem, it has been difficult to significantly increase the number of bubbles at low costs.

Also, because of the same reason, there has been another problem with adding large amounts of nucleating agent. Essentially, a nucleating agent is a foreign substance, and because the dielectric constant of most foam nucleating agents currently being in practical use is larger than that of the matrix polymer, adding large amounts of nucleating agent adversely affects dielectric characteristics of resin composition, resulting in impairing the advantage of the foam.

### SUMMARY OF THE INVENTION

Under these circumstances, it is an objective of the present invention to address the above problems and to provide an electric-wire cable having a foamed insulator which has acquired a high foaming degree and stable fine bubbles by a simple and easy method. By doing so, it is possible to provide an electric-wire cable having a foamed insulator which enables high-speed transmission, has a low skew, and is excellent in mechanical strength.

According to one aspect of the present invention, there is provided an electric-wire cable equipped with a foamed insulator, the foamed insulator molded on an outer periphery of a metal conductor by a physical foaming method, in which: the foamed insulator is made of a blend of crystalline polymer A with polymer B; and the crystal melting point or glass transition temperature of the polymer B is between the crystal melting point of the crystalline polymer A and a temperature 50° C. lower than the crystal melting point of the crystalline polymer A.

In the above aspect of the present invention, the following modifications and changes can be made.

(i) The content of the polymer B is 0.1 to 45 weight % with regard to the total amount of the crystalline polymer A and the polymer B.

(ii) The crystalline polymer A is polyethylene and the polymer B has a polystyrene block.

(iii) The foamed insulator does not contain a chemical foaming agent.

### ADVANTAGES OF THE INVENTION

According to the present invention, by blending crystalline polymer A with polymer B which has a low crystal melting point or a low glass transition temperature and by foaming physically, it is possible to achieve a high foaming degree as well as maintain stable fine bubbles. By doing so, it is possible to obtain an electric-wire cable having a foamed insulator that enables high-speed transmission, has a low skew, and is excellent in mechanical strength. Also, since an electric-wire cable according to the present invention does not use a chemical foaming agent, there is no problem caused by foaming agent residue, and an insulator having small fluctuation of the foaming degree can be obtained.

### BRIEF DESCRIPTION OF THE DRAWINGS

FIG. 1 is a schematic illustration showing a cross-sectional view of an electric wire equipped with a foamed insulator according to the present invention.

FIG. 2 is a schematic illustration showing a cross-sectional view of a co-axial cable equipped with a foamed insulator according to the present invention.

FIG. 3 is a schematic illustration showing a cross-sectional view of another electric-wire cable equipped with a foamed insulator according to the present invention.

FIG. 4 is a schematic illustration showing a cross-sectional view of still another electric-wire cable equipped with a foamed insulator according to the present invention.

FIG. 5 is a schematic illustration showing a cross-sectional view of still another electric-wire cable equipped with a foamed insulator according to the present invention.

FIG. 6 is a graph showing temporal fluctuation of the converted foaming degree in Example 1 of the present invention.

FIG. 7 is a graph showing a relationship between the fluctuation of the foaming degree and the skew in Examples 1 to 13 of the present invention.

### DETAILED DESCRIPTION OF THE PREFERRED EMBODIMENTS

Hereafter, a preferred embodiment of the present invention will be described in detail with reference to the attached drawings. However, the present invention is not limited to the embodiment described herein.

(Configuration of Electric-Wire Cable)

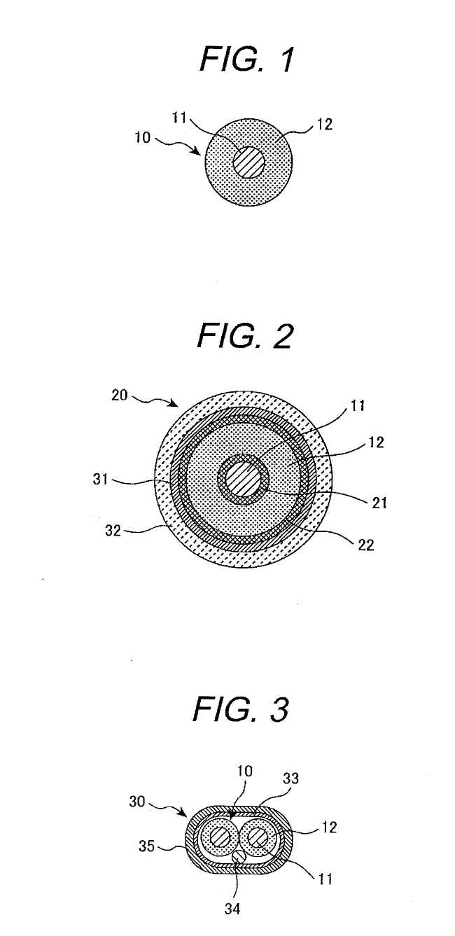

First, an electric-wire cable having a foamed insulator according to the present invention will be described with reference to FIGS. 1 to 5.

FIG. 1 is a schematic illustration showing a cross-sectional view of an electric wire equipped with a foamed insulator according to the present invention. As shown in FIG. 1, an electric wire 10 comprises a conductor 11 and a foamed insulator 12 having a large number of bubbles, the foamed insulator 12 being extrusion-coated on the conductor 11.

FIG. 2 is a schematic illustration showing a cross-sectional view of a co-axial cable equipped with a foamed insulator according to the present invention. As shown in FIG. 2, a co-axial cable 20 is constructed such that: an internal skin layer 21 is formed right on top of the conductor (internal conductor) 11 to bond the foamed insulator 12 with the conductor 11; an external skin layer 22 is formed in the outer periphery portion of the foamed insulator 12 to prevent the foaming degree from decreasing due to outgassing at the processing; an external conductor 31 is formed on the outer periphery of the external skin layer 22; and then a sheath layer 32 is formed on the outer periphery of the external conductor 31.

The foamed insulator 12, internal skin layer 21, and external skin layer 22 can be sequentially coated by tandem extrusion or the like, or can be formed by simultaneous extrusion using a common head. The internal skin layer 21 or external skin layer 22 can be omitted if there is no occurrence of outgassing and sufficient cable characteristics can be ensured.

The conductor 11 can be a single wire or a twisted wire, and besides the copper wire, a variety of alloy wires and, in some cases, a tube-type conductor can be used. Furthermore, it is possible to plate the surface with silver, tin, or other arbitrary substances. For example, it is possible to use a copper coated aluminum conductor in which the surface of an aluminum conductor is coated with copper.

A foamed insulator 12 containing bubbles can be a single layer or a combination of plural foamed layers. The skin layers 21, 22 located in the inner periphery portion and the outer periphery portion of the foamed insulator 12 can be not foamed layers or foamed layers having extremely low foaming degree in comparison with the foamed insulator 12.

According to the purpose of use and required performance, the external conductor 31 formed on the outer periphery of the external skin layer 22 can be arbitrarily created such that: an extra-fine metal wire is transversely wound or braided; or foil of metal, such as copper, aluminum, or the like, is wound; or the conductor can be a corrugated tube created by welding and processing a metal tape, such as a copper tape. Furthermore, arbitrary material, such as polyolefin including PE (polyethylene), PP (polypropylene) and the like, fluoropolymer, polyvinyl-chloride, and halogen-free fire-retarding material, can be used for the material of the sheath layer 32 outside the external conductor 31.

Regardless of the presence or absence of the external conductor 31, the configuration of the electric-wire cable can be arbitrarily chosen. To take an example, electric-wire cables 30, 30′ and 40 shown respectively in FIGS. 3 to 5 can be created, in addition to the method in which a single external conductor 31 having a sheath layer 32 provided on the outer periphery thereof is used as shown in FIG. 2.

FIG. 3 is a schematic illustration showing a cross-sectional view of another electric-wire cable equipped with a foamed insulator according to the present invention. There is provided an electric-wire cable 30 such that: a plurality of electric wires 10 are arranged in parallel; a drain wire (grounding wire) 34 is also provided; and the outer periphery thereof is entirely covered by a shielding layer 33 and then further covered by a retainer tape 35.

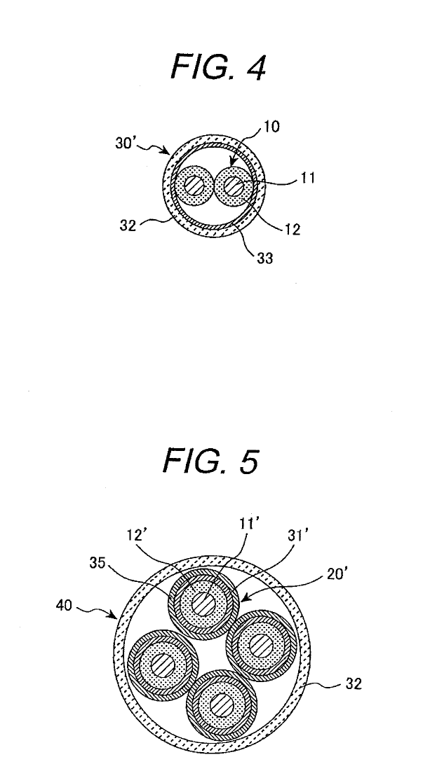

FIG. 4 is a schematic illustration showing a cross-sectional view of still another electric-wire cable equipped with a foamed insulator according to the present invention. An electric-wire cable 30′ is constructed such that: electric wires 10 are twisted; a drain wire 34 is provided as necessary (not shown); and the outer periphery thereof is entirely covered by a shielding layer 33 and further covered by a sheath layer 32.

FIG. 5 is a schematic illustration showing a cross-sectional view of still another electric-wire cable equipped with a foamed insulator according to the present invention. As shown in FIG. 5, there is provided an electric-wire cable 40 such that: an extra-fine foamed insulator 12′ is formed on the outer periphery of the extra-fine internal conductor 11′, an external conductor 31′ is created on the outer periphery of the extra-fine foamed insulator 12′ by transversely winding an extra-fine metal wire, and then the whole structure is protected by a retainer tape 35, thereby creating an extra-fine co-axial cable 20′; a plurality of (four in the drawing) the extra-fine co-axial cables 20′ are arranged in parallel or twisted; and a sheath layer 32 is created on the outer periphery of the arranged extra-fine co-axial cables.

(Foamed Insulator)

When creating a foamed insulator, the inventors of the present invention keenly examined resin composition to form uniformly fine bubbles in the foamed insulator at the time of physical foaming by infusing a gas into an extruder. Thus, the present invention has been achieved.

That is, a foamed insulator according to the present invention is made of a blend of crystalline polymer A with polymer B, wherein the crystal melting point or glass transition temperature of the polymer B is contrived between the crystal melting point of the crystalline polymer A and a temperature 50° C. lower than the crystal melting point of the crystalline polymer A.

With regard to the resin viscosity in the physical foam molding process, it is preferable that melt viscosity be as high as possible in order to prevent outgassing to the outside of the resin layer during the bubble growth period as well as prevent bubbles from coalescing and coarsening. For this reason, resin temperature during the foamed insulator extrusion process is set at a temperature as low as possible within a range in which processing is possible. For a crystalline polymer, it is important to control temperature so that the temperature keeps a little (approximately 10 to 30° C.) higher than the melting point.

On the other hand, after having been extruded from the dice, the temperature of resin in the bubble growth process rapidly decreases due to the mechanism of depriving the insulator surface of heat by air or water or by the inner wall of the cooling sizing die as well as the effect of temperature decrease by adiabatic expansion at the time of foaming. The inventors of the present invention revealed that resin temperature at the time of bubble generation was 40 to 50° C. lower than the temperature at the time when the resin passed through the dice.

In the blended polymer for the foamed insulator according to the present invention, because the crystalline polymer A has a higher crystal melting point than the polymer B, the crystallization of polymer A occurs more anterior than the solidification of polymer B during cooling. With crystallizing the polymer A, foaming gas molecular dissolved in the crystalline polymer A is excluded from the crystallized polymer chain (crystallized region), and the gas molecular concentration increases in a still amorphous region of the blended polymer. On the other hand, the crystallization of polymer A is the most likely to occur at an interface between the polymers A and B. Therefore, the gas molecular concentration around the interface becomes remarkably high, which causes to generate a bubble nucleus by thermal fluctuation of the foaming gas.

When the content of polymer B is 0.1 to 45 weight % with regard to the total amount of blended polymer (crystalline polymer A and polymer B), the polymer B can uniformly disperse in the polymer A, and the number of generated bubbles can effectively increase. If the content of polymer B is less than 0.1 weight %, the addition is not effective. And if the content of polymer B is more than 45 weight %, mechanical strength of the foamed insulator decreases and the insulator easily deforms.

It is preferable that the crystalline polymer A of the present invention be polyethylene. Polyethylene has a small dielectric constant, which can reduce transmission loss, and polyethylene is inexpensive since it is a general-purpose polymer. It is preferable that the crystalline polymer A is a mixture of high-density polyethylene and low-density polyethylene. The dielectric characteristics of high-density polyethylene include small tans, which is advantageous for reducing transmission loss in the cable. However, because of a linear-chain type in which the molecular structure does not have branches, melt viscosity is low and high-density polyethylene is not suitable for foam molding when used singly. On the other hand, low-density polyethylene has high melting viscosity because of the branched molecular structure, and when low-density polyethylene is blended with high-density polyethylene, the degree of foaming can be increased.

In the present invention, when the crystalline polymer A has a plurality of crystal melting points, the crystal melting point of polymer A is defined as the crystal melting point of the highest temperature. This is because melting and extruding of the polymer A must be conducted at a temperature higher than the highest temperature of the crystal melting point.

Besides polyethylene (PE), the crystalline polymer A can be as follows: ethylenic polymers, such as ethylene-vinyl acetate copolymer (EVA), ethylene-ethyl acrylate copolymer (EEA), ethylene-methyl acrylate copolymer (EMA), ethylene-methyl methacrylate copolymer (EMMA), ethylene-α-olefin copolymer, high-density polyethylene (HDPE, crystal melting point Tm of 130° C.), low-density polyethylene (LDPE, Tm of 110° C.), linear low-density polyethylene (LLDPE), very-low-density polyethylene (VLDPE), ethylene-butene 1 copolymer, ethylene-hexene copolymer, ethylene-octene copolymer, and the like; propylene-type polymers, such as homo polypropylene (h-PP), block polypropylene (b-PP), random polypropylene (r-PP), and the like; fluoropolymer, such as polytetrafluoroethylene (PTFE, Tm of 327° C.), polyfluoroalkoxy (PFA, Tm of 300° C.), tetrafluoroethylene-propylene copolymer (FEP, Tm of 260° C.), polychlorotrifluoroethylene (PCTFE, Tm of 245° C.), and the like; polyester-type resin, such as polybutylene terephthalate (PBT), polyethylene terephthalate (PET), polyester elastomer, and the like; engineering plastics, such as polyphenylene sulfide (PPS), polyamide (PA), polyether sulfone (PES), and the like.

A single substance of those or a mixture of two or more of the above substances can be used. It is preferable that the crystalline polymer A is polyethylene or fluoropolymer, and a mixture of HDPE and LDPE is most preferred.

The polymer B can be any polymer without limitation as long as the polymer has a glass transition temperature (Tg) or a crystal melting point (Tm) in the temperature range between the crystal melting point of the crystalline polymer A and a temperature 50° C. lower (Tm−-50° C.) than the crystal melting point of the crystalline polymer A. Furthermore, either a crystalline polymer or a non-crystalline polymer is acceptable for the polymer B.

For example, when the crystalline polymer A is polyolefin-type polymer, any polymer can be selected as polymer B from polystyrene (PS), styrene-ethylenebutylene-styrene terpolymer (SEBS, Tg of 100° C.), styrene-ethylenepropylene-styrene terpolymer (SEPS, Tg of 100° C.), styrene-(ethylene-ethylenepropylene)-styrene copolymer (SEEPS), styrene-olefin-block (graft) copolymer, or EVA, EEA, EMA, EMMA, PMMA as long as the polymer has a melting point or a glass transition temperature within the prescribed range.

When the crystalline polymer A is fluoropolymer, preferred polymer as polymer B is any of polyphenylene sulfide (PPS), polycarbonate (PC, Tm of 145° C.), polyphenylene ether (PPE, Tm of 210° C.), PS/PPE polymer alloy, polyether sulfone (PES, Tm of 223° C.), polyacetal (POM), FEP, and ethylene-tetrafluoroethylene copolymer (ETFE). However, the polymer B is not intended to be limited to those polymers regardless of whether the crystalline polymer A is olefin or fluoric polymer.

Especially preferred combinations are as follows: When the crystalline polymer A is polyethylene, styrene-type elastomer typified by SEBS and SEPS which have a small dielectric constant and a small tans at high frequency is preferred, and specifically, SEBS or SEPS having a PS content of 20% or less is more preferred because of the large number of generated bubbles. When the polymer A is a fluoric polymer, preferred is PPE or modified PPE (PPE/PS polymer alloy) having a small dielectric constant as polymer B.

### Embodiment

Hereafter, embodiments of the present invention will be described in detail.

First, the foamed insulator 12, 12′ described with reference to FIGS. 1 to 5 is extruded directly on the outer periphery of the conductor 11, 11′ or on the outer periphery of the internal skin layer 21 formed on the outer periphery of the internal conductor.

With regard to the total amount of resin, this foamed insulator comprises:

polymer A including

55 to 95 parts by weight of high-density polyethylene (HDPE) and

45 to 5 parts by weight of low-density polyethylene (LDPE);

polymer B including

0.1 to 45 parts by weight of styrene elastomer.

The content of polymer B used for the present invention is 0.1 to 45 weight % is preferred with regard to the total amount of polymer A and polymer B, and 1 to 30 weight % is more preferred. If the amount of addition of polymer B is too small, the effect of nucleation agent becomes insufficient, resulting in coarsening bubbles, decreasing the degree of foaming, or increasing fluctuations. If the amount of addition of polymer B is too much, properties of extrusion molding significantly decrease. Especially, in the case of polymer B addition more than 45 weight %, the mechanical strength of the foamed insulator decreases, causing deformation or buckling to occur. If deformation or buckling occurs to the foamed insulator during production or use of electric wires, unfavorable situations occur in that impedance fluctuates, delay time increases, and transmission loss increases.

Furthermore, in terms of thermal resistance, the foamed insulator according to the present invention can use polymers in which molecules are cross-linked. For a cross-linking method, chemical cross-linking, such as peroxide cross-linking by organic peroxides, sulfur cross-linking by sulfur compounds, and the like; irradiation cross-linking by electron beams, radial rays, and the like; or other chemical reactions can be used. In terms of high frequency dielectric characteristics, the electron-beam irradiation cross-linking is preferred.

Also, those resin compositions can include, as necessary, a flame-retarding agent, flame-retarding auxiliary agent, lubricant, antistatic agent, surfactant, softener, plasticizer, inorganic filler, compatibilizing agent, stabilizer, ultraviolet absorber, light stabilizer, cross-linking auxiliary agent, colorant, antioxidant, viscosity regulator, and other additives. However, metal oxide or metal salt cannot be added even though it is an additive that satisfies those functions because metal oxide and metal salt adversely affect the dielectric constant.

The following three methods are applicable to supply the crystalline polymer A or the polymer B to an extruding machine.

(I) A dry-blend method in which pellet or powder type polymer according to the present invention is directly put into the extruder;

(II) A master batch method in which the polymer B is beforehand mixed with the polymer A or another polymer at high concentration so as to form a resin composition, and the resin composition is added as a master batch into the polymer A in the extruder; and

(III) A full-compound method in which a resin composition is created by beforehand putting the polymer A and the polymer B into a kneading machine, such as a twin-screw extruder, or the like, and kneading the mixture, and then the resin composition is put into the extruder.

Considering the dispersion condition of the polymer B, the full-compound method, described in item (III), is most preferred. This is because a large number of fine bubbles are generated as the result of uniform dispersion of the polymer B, which enables uniform growth as well as significantly stabilizes both the outer diameter and the capacitance. Thus, it is possible to produce an ideal foamed wire having a high foaming degree and a low skew.

### Examples

Next, the present invention will be described by referring Examples 1 to 14 and Comparative examples 1 to 5. In order to examine skew of an electric wire, prototypes of electric-wire cable 30 having a structure in FIG. 3 were manufactured in both the examples and comparative examples as described below.

Resin and additives shown in Table 1 (Examples 1 to 13), Table 2 (Example 14), and Table 3 (Comparative examples 1 to 5) are put into a 45-mm twin-screw extruder and kneaded at a temperature specified in the tables, and thus, a full compound for producing an electric wire was blended.

TABLE 1

| | Polymer | | Tm or Tg | Example 1 | Example 2 | Example 3 | Example 4 | Example 5 |
|---|---|---|---|---|---|---|---|---|
| Polymer A | HDPE | DGDA-6944 *1 | Tm = 130° C. | 99.9 pbw | 99.95 pbw | 90 pbw | 90 pbw | 76 pbw |
| | LDPE | DFDA-1253 *1 | Tm = 110° C. | | | | | 14 pbw |
| Polymer B | SEBS | Tuftec | Tg = 100° C. | 0.1 pbw | 0.05 pbw | | 10 pbw | 10 pbw |
| | | H1052 *2 | (St = 20%) | | | | | |
| | SEBS | Tuftec | Tg = 100° C. | | | | | |
| | | H1043 *2 | (St = 67%) | | | | | |
| | SEPS | Septon | Tg = 100° C. | | | 10 pbw | | |
| | | 2004 *3 | (St = 18%) | | | | | |
| | St-g-PE | VMX *4 | Tg = 100° C. | | | | | |
| | | | (St = 30%) | | | | | |
| | PMMA | ACRYPET MD *5 | Tg = 105° C. | | | | | |
| | EVA | V422 | Tm = 83° C. | | | | | |
| | | (20% VA) *6 | | | | | | |
| Kneading temperature (° C.) | | | | 200 | 200 | 200 | 200 | 200 |
| Fluctuation of foaming degree during | | | | 2.6 | 3.3 | 2.0 | 1.7 | 1.5 |
| extrusion (%) | | | | | | | | |
| Within-pair skew (ps/m) | | | | 8.2 | 9.5 | 6.5 | 5.4 | 6.0 |
| (Evaluation) | | | | Passed | Passed | Excellent | Excellent | Excellent |
| Thermal deformation ratio (%) | | | | 8.0 | 8.0 | 8.5 | 9.0 | 11.0 |
| (Evaluation) | | | | Excellent | Excellent | Excellent | Excellent | Passed |
| | Polymer | | Tm or Tg | Example 6 | Example 7 | Example 8 | Example 9 | Example 10 |
| Polymer A | HDPE | DGDA-6944 *1 | Tm = 130° C. | 76 pbw | 76 pbw | 76 pbw | 81 pbw | 76 pbw |
| | LDPE | DFDA-1253 *1 | Tm = 110° C. | 14 pbw | 14 pbw | 14 pbw | 14 pbw | 14 pbw |
| Polymer B | SEBS | Tuftec | Tg = 100° C. | | | | | |
| | | H1052 *2 | (St = 20%) | | | | | |
| | SEBS | Tuftec | Tg = 100° C. | 10 pbw | | | | |
| | | H1043 *2 | (St = 67%) | | | | | |
| | SEPS | Septon | Tg = 100° C. | | 10 pbw | | | |
| | | 2004 *3 | (St = 18%) | | | | | |
| | St-g-PE | VMX *4 | Tg = 100° C. | | | 10 pbw | | |
| | | | (St = 30%) | | | | | |
| | PMMA | ACRYPET MD *5 | Tg = 105° C. | | | | 5 pbw | |
| | EVA | V422 | Tm = 83° C. | | | | | 10 pbw |
| | | (20% VA) *6 | | | | | | |

| | | | | | |
|---|---|---|---|---|---|
| Kneading temperature (° C.) | 200 | 200 | 200 | 200 | 200 |
| Fluctuation of foaming degree during | 1.4 | 1.2 | 1.7 | 2.2 | 2.7 |
| extrusion (%) | | | | | |
| Within-pair skew (ps/m) | 5.7 | 4.4 | 8.2 | 7.2 | 9.6 |
| (Evaluation) | Excellent | Excellent | Passed | Excellent | Passed |
| Thermal deformation ratio (%) | 7.0 | 9.5 | 11.5 | 13.0 | 12.5 |
| (Evaluation) | Excellent | Excellent | Passed | Passed | Passed |

| | Polymer | | Tm or Tg | Example 11 | Example 12 | Example 13 |
|---|---|---|---|---|---|---|
| Polymer A | HDPE | DGDA-6944 *1 | Tm = 130° C. | 60 pbw | 55 pbw | 50 pbw |
| | LDPE | DFDA-1253 *1 | Tm = 110° C. | 10 pbw | | |
| Polymer B | SEBS | Tuftec | Tg = 100° C. | | | |
| | | H1052 *2 | (St = 20%) | | | |
| | SEBS | Tuftec | Tg = 100° C. | | | |
| | | H1043 *2 | (St = 67%) | | | |
| | SEPS | Septon | Tg = 100° C. | 30 pbw | 45 pbw | 50 pbw |
| | | 2004 *3 | (St = 18%) | | | |
| | St-g-PE | VMX *4 | Tg = 100° C. | | | |
| | | | (St = 30%) | | | |
| | PMMA | ACRYPET MD *5 | Tg = 105° C. | | | |
| | EVA | V422 | Tm = 83° C. | | | |
| | | (20% VA) *6 | | | | |

| | | | |
|---|---|---|---|
| Kneading temperature (° C.) | 200 | 200 | 200 |
| Fluctuation of foaming degree during | 1.2 | 1.5 | 2.0 |
| extrusion (%) | | | |
| Within-pair skew (ps/m) | 5.5 | 7.0 | 7.2 |
| (Evaluation) | Excellent | Excellent | Excellent |
| Thermal deformation ratio (%) | 13.0 | 14.0 | 15.0 |
| (Evaluation) | Passed | Passed | Passed |

*1: The Dow Chemical Company,
*2: Asahi Kasei Corporation,
*3: Kuraray Plastics Co., Ltd.,
*4: Mitsubishi Chemical Corporation,
*5: Mitsubishi Rayon Co., Ltd.,
*6: Mitsui-Du pont Polychemicals Co., Ltd.,
20% VA: vinyl acetate content = 20 weight %, St-g-PE: polystyrene grafted polyethylene, St: styrene content (%), pbw: parts by weight.

TABLE 2

| | | | | Example |
|---|---|---|---|---|
| | Polymer | | Tm or Tg | 14 |
| Polymer A | PCTFE | Neoflon | Tm = 245° C. | 90 pbw |
| | | M-300PL *7 | | |
| Polymer B | PPE | Mw = 50,000 | Tg = 210° C. | 10 pbw |

| | |
|---|---|
| Kneading temperature (° C.) | 280 |
| Fluctuation of foaming degree during | 1.8 |
| extrusion (%) | |
| Within-pair skew (ps/m) | 7.8 |
| (Evaluation) | Excellent |
| Thermal deformation ratio (%) | 13.6 |
| (Evaluation) | Passed |

*7: Daikin Industries, Ltd., Mw: weight average molecular weight.

TABLE 3

| | | | | Comparative | Comparative | Comparative | Comparative | Comparative |
|---|---|---|---|---|---|---|---|---|
| | Polymer | | Tm or Tg | example 1 | example 2 | example 3 | example 4 | example 5 |
| Polymer A | HDPE | DGDA-6944 | Tm = 130° C. | 100 pbw | 70 pbw | 76 pbw | 76 pbw | |
| | LDPE | DFDA-1253 | Tm = 110° C. | | 30 pbw | 14 pbw | 14 pbw | |
| | PFA | Neoflon | Tm = 304° C. | | | | | 90 pbw |
| | | AP-231SH | | | | | | |
| Polymer B | EVA | Ultrathene | Tm = 72° C. | | | 10 pbw | | |
| | | 751 *10 | | | | | | |
| | PP | Catalloy | Tm = 142° C. | | | | 10 pbw | 10 pbw |
| | | Q100F *11 | | | | | | |
| | SEPS | Septon | Tg = 100° C. | | | | | |
| | | 2004 | | | | | | |

| | | |
|---|---|---|
| Additive-type | ADCA *12 | 0.5 pbw |
| nucleation agent | | |

| | | | | | |
|---|---|---|---|---|---|
| Kneading temperature (° C.) | — | 180 | 180 | 200 | 320 |
| Fluctuation of foaming degree during | 7.5 | 3.8 | 4.7 | 5.1 | 6.2 |
| extrusion (%) | | | | | |
| Within-pair skew (ps/m) | 18.4 | 11.0 | 12.4 | 13.5 | 16.2 |
| (Evaluation) | Failed | Failed | Failed | Failed | Failed |
| Thermal deformation ratio (%) | 6.5 | 7.5 | 8.2 | 7.5 | 9.1 |
| (Evaluation) | Excellent | Excellent | Excellent | Excellent | Excellent |

*10: Tosoh Corporation,
*11: SunAllomer Ltd.,
*12: Eiwa Chemical Ind. Co., Ltd.

By using each of those full compounds shown in Tables 1 to 3 and by providing conditions shown in Table 4, there was fabricated a 10,000-meter wire having a foamed insulator whose target foaming degree was 50%. Then, 1-Mrad electron beam was irradiated onto the insulator to execute electron-beam cross-linking. After that, the wire was halved, and the two 5,000-meter wires were arranged in parallel together with a drain wire, an aluminum shielding tape was longitudinally folded, and then the entire structure was spirally wrapped by a PET tape. Thus, twenty 10-meter cables having a twinax structure (see FIG. 3) were prepared for each compound.

TABLE 4

| Item | Condition |
|---|---|
| Extruder screw diameter D | 45 mm |
| Extruder screw length L | 1300 mm |
| L/D | 29 |
| Infused gas | N₂ |
| Gas pressure | 36 to 38 MPa |
| Conductor diameter | AWG 24 (0.51 mm) |
| Type of conductor | Tin-plated copper wire |
| Extrusion rate | 180 to 200 m/min |
| Extrusion temperature | 150 to 170° C. |
| | (polyethylene-type: |
| | Examples 1 to 13) |
| | 300° C. |
| | (fluoropolymer-type: |
| | Example 14) |
| Target outer diameter | 1.45 mm |
| Target foaming degree | 50% |

During the extrusion of a wire having a foamed insulator, outer diameter (b) and capacitance (C) of the wire were monitored inline, and the changes over time were measured. Then, specific dielectric constant was calculated from conductor diameter (a) and the monitored values of b and C. Furthermore, a converted foaming degree was calculated according to the formula of A. S. Windeler.

The effective specific dielectric constant εᵣ of the foamed insulator was obtained by the following equation 1. ε₀ is a dielectric constant of vacuum.

$${ɛ}_{r} = \frac{C \cdot ln ( b / a )}{2 π \cdot {ɛ}_{0}} \qquad Eq . 1$$

The converted foaming degree was obtained by the following equation 2 according to the formula of A. S. Windeler. In Eq. 2, δᵢ is a specific dielectric constant of insulator material and the specific dielectric constant of air is 1.

$$F = \frac{2 {ɛ}_{r} + 1}{3 {ɛ}_{r}} \times \frac{{ɛ}_{i} - {ɛ}_{r}}{{ɛ}_{i} - 1} \qquad Eq . 2$$

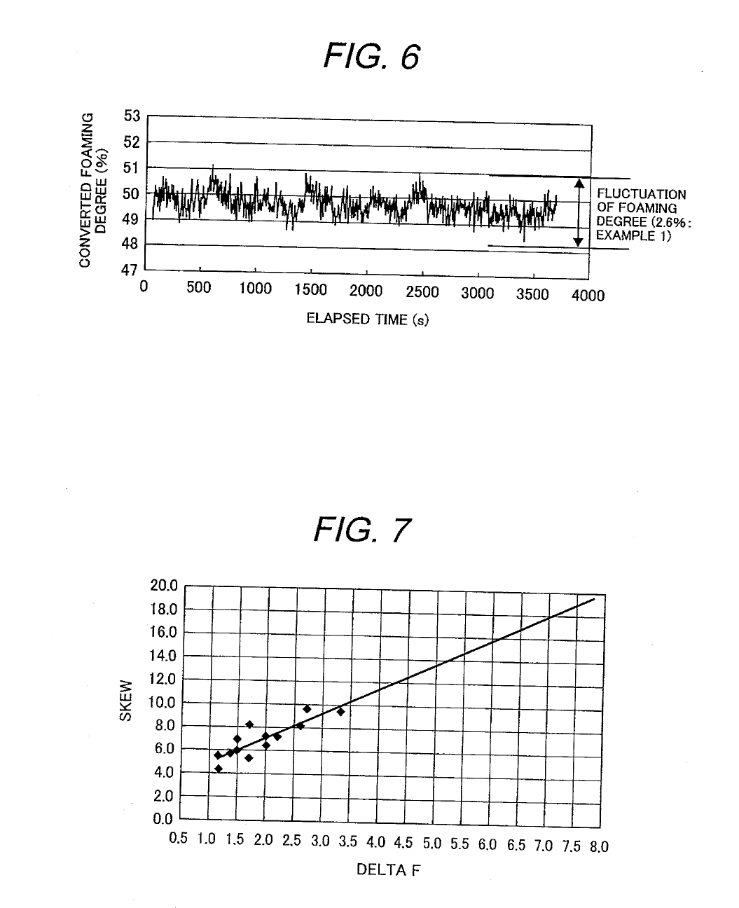

FIG. 6 is a graph showing temporal fluctuation of the converted foaming degree in Example 1 of the present invention. Difference between the maximum and the minimum values of the converted foaming degree is defined as fluctuation (ΔF) of the foaming degree. As shown in FIG. 6, 2.6% was the fluctuation (ΔF) of the foaming degree in Example 1.

The skew and thermal deformation of Examples 1 to 14 and Comparative examples 1 to 5 in Tables 1 to 3 were measured according to the following.

(1) Measurement of Skew

The within-pair skew of a 10-meter twinax cable was measured by the TDT (time domain transmission) method. FIG. 7 is a graph showing a relationship between the fluctuation (AF) of the foaming degree and the skew in Examples 1 to 13 of the present invention. As shown in FIG. 7, each of skew in Examples 1 to 13 was 10 ps/m or less.

Evaluation of skew property in Tables 1 to 3 was conducted as follows: in 20 cables, a cable having a maximum skew within pair per unit length being 10 ps/m or less was regarded as passed and especially, a cable having the value being 8 ps/m or less was considered excellent. Furthermore, a cable having the value being more than 10 ps/m was regarded as failed.

(2) Thermal Deformation

A prototype electric wire sample was cut into 7-cm pieces; ten samples of the 7-cm wire were arranged in a line along a width direction; and a probe (SUS semicylinder with a diameter of 5 mm) was provided on and across (perpendicular to) the samples. The wire samples were heated and left at rest for 30 minutes in the 10 N loaded environment, and then the ratio of deformation with regard to the initial value was calculated.

By assuming an actual use environment, test temperature was set at 70° C. for polyethylene type and 120° C. for fluoropolymer type. When the deformation ratio was 15% or less, the wire was regarded as passed and particularly, the wire having the ratio of 10% or less was considered excellent.

As stated above, in Examples 1 to 13, shown in Table 1, wherein polyethylene having a melting point (Tm) of 130° C. was used as a crystalline polymer A, and as a polymer B, styrene-type polymer having a glass transition temperature (Tg) of 100° C. or PMMA (a glass transition temperature thereof exists between the polyethylene's crystal melting point of 130° C. and 80° C. which is 50° C. lower than the melting point) or EVA having a crystal melting point of 83° C. was used, fluctuation of the foaming degree was small. That is, the microstructure of the foamed insulator was stable.

A twinax cable which used the above-mentioned electric wires had a small within-pair skew and good transmission characteristics. Since the thermal deformation test result was also acceptable, the mechanical strength thereof is also sufficient. Besides, in Example 13 wherein the polymer B of 50 weight % was mixed, although the result of the thermal deformation ratio was acceptable, it is relatively high, and there was no margin.

Furthermore, similarly in Example 14, shown in Table 2, wherein fluoropolymer was used as a crystalline polymer A and a prescribed polymer was used as a polymer B, fluctuation of outer diameter was small and the microstructure of the foamed insulator was stable. The twinax cable that used the above-mentioned electric wires had a small within-pair skew and good transmission characteristics.

On the other hand, as shown in Table 3, in Comparative example 1 which did not use a polymer B, Comparative example 2 that used conventional additive-type foam nucleation agent ADCA (azodicarbonamide), and Comparative examples 3 to 5 wherein the crystal melting point of polymer B was not a prescribed value, the fluctuation of foaming degree was large, resulting in the increase in within-pair skew of the twinax cable, consequently, the wire samples were regarded as failed.

According to the above results, it was demonstrated that an electric-wire cable of the present invention had a small skew and exhibited good transmission characteristics, the electric-wire cable comprising a metal conductor and a foamed insulator covering the outer periphery of the conductor and fabricated by the physical foaming method, the foamed insulator being created by blending a crystalline polymer A with a polymer B, and the crystal melting point or glass transition temperature of the polymer B being between the crystal melting point of the crystalline polymer A and the temperature 50° C. lower than the crystal melting point.

Although the present invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An electric-wire cable equipped with a foamed insulator, the foamed insulator molded on an outer periphery of a metal conductor by a physical foaming method, wherein:
the foamed insulator is made of a blend of crystalline polymer A and polymer B; and
crystal melting point or glass transition temperature of the polymer B is between crystal melting point of the crystalline polymer A and a temperature 50° C. lower than the crystal melting point of the crystalline polymer A.

2. The electric-wire cable equipped with a foamed insulator according to claim 1, wherein
content of the polymer B is 0.1 to 45 weight % with regard to the total amount of the crystalline polymer A and the polymer B.

3. The electric-wire cable equipped with a foamed insulator according to claim 1, wherein
the crystalline polymer A is polyethylene and the polymer B has a polystyrene block.

4. The electric-wire cable equipped with a foamed insulator according to claim 1, wherein
a chemical foaming agent is not contained.
